(19) United States
(12) Patent Application Publication
(10) Pub. No.: US 2008/0247465 A1
(43) Pub. Date: Oct. 9, 2008

(54) Method and System for Mapping Motion Vectors between Different Size Blocks

(76) Inventors: Jun Xin, Quincy, MA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/696,937

(22) Filed: Apr. 5, 2007

(51) Int. Cl. H04N 11/02

(52) U.S. Cl. 375/240.16

(57) ABSTRACT

A method and system for mapping motion vectors. A weight is determined for each motion vector of a set of input blocks of an input bitstream. Then, the set of motion vectors are mapped to an output motion vector of an output block of an output bitstream according to the set of weights.

### FIELD OF THE INVENTION

The invention related generally to video signal processing, and more particularly to mapping motion vectors.

### BACKGROUND OF THE INVENTION

MPEG-2 is currently the primary format for coding videos. The H.264/AVC video coding standard promises the same quality as MPEG-2 in about half the storage requirement, ITU-T Rec. H.264|ISO/IEC 14496-10, “Advanced Video Coding,” 2005, incorporated herein by reference. The H.264/AVC compression format is being adopted into storage format standards, such as Blu-ray Disc, and other consumer video recording systems. As more high-definition content becomes available and the desire to store more content or record more channels simultaneously increases, long recording mode will become a key feature. Therefore, there is need to develop techniques for converting MPEG-2 videos to the more compact H.264/AVC format with low complexity. The key to achieving low complexity is to reuse information decoded from an input MPEG-2 video stream.

An MPEG-2 decoder connected to a H.264/AVC encoder can form a transcoder. This is referred to as a reference transcoder. The reference transcoder is very computationally complex due to the need to perform motion estimation in the H.264/AVC encoder. It is well understood that one can reduce the complexity of the reference transcoder by reusing the motion and mode information form the input MPEG-2 video bitstream, see A. Vetro, C. Christopoulos, and H. Sun, “Video transcoding architectures and techniques: an overview, ” IEEE Signal Processing Mag. 20(2): 18-19, March 2003. However, the reuse of such information in the most cost-effective and useful manner is a known problem.

FIG. 1 shows a prior art video transcoder 100. An input MPEG-2 bitstream 101 is provided to an MPEG-2 video decoder 110. The decoder outputs decoded picture data 111 and control data 112, which includes MPEG-2 header information and macroblock data. The MPEG-2 macroblock data includes motion information 121 and mode information 131 for each input macroblock of the MPEG-2 bitstream. This information is provided as input to motion mapping 120 and mode decision 130, which estimates H.264 macroblock data including motion and mode information for each output macroblock of the H.264 bitstream. The H.264 macroblock data and the decoded picture data are then used to perform a simplified H.264/AVC encoding, which includes prediction 140, difference 150 between decoded picture data and prediction, transform/quantization (HT/Q) 160, entropy coding 170, inverse transform/quantization (Inverse Q/Inverse HT) 180 to yield a reconstructed residual signal, summation 185 of the reconstructed residual signal with the prediction, deblocking filter 190 and storage of a reconstructed picture into frame buffers 195. The encoder is “simplified” relative to the reference transcoder, because the motion and mode information are based on the input MPEG-2 video bitstream and corresponding MPEG-2 macroblock data.

Methods for motion mapping in a transcoder are described by Z. Zhou, S. Sun, S. Lei, and M. T. Sun “Motion information and coding mode reuse for MPEG-2 to H.264 transcoding,” IEEE Int. Symposium on Circuits and Systems, pages 1230-1233, 2005, and X. Lu, A. Tourapis, P. Yin, and J. Boyce, “Fast mode decision and motion mapping for H.264 with a focus on MPEG-2/H.264 transcoding,” In IEEE Int. Symposium on Circuits and Systems, 2005.

However, those methods require a complex motion mapping process. For inter 16×16 prediction, the motion vectors from the input MPEG-2 video bitstream are used as additional motion vector predictors. For smaller block sizes, e.g., 16×8, 8×16 and 8×8, motion vectors cannot be estimated directly from the input motion vectors because MPEG-2 does not include such motion vectors. Instead, the motion vectors are estimated using conventional encoding processes without considering the MPEG-2 motion vectors. Therefore, such methods still need very complicated motion search processes.

There are no prior art methods that perform efficient mapping of mapping MPEG-2 motion vectors directly to H.264/AVC motion vectors, regardless of the block sizes. There is a need to perform such a mapping without complex motion search processes.

### SUMMARY OF THE INVENTION

The embodiments of the invention provide a method for mapping motion vectors between blocks with different sizes. A motion vector for a output block is estimated from a set of input motion vectors and spatial properties of a set of input blocks. A input block either overlaps or is neighboring to the output block. A motion refinement process can be applied to the estimated motion vector.

### BRIEF DESCRIPTION OF THE DRAWINGS

FIG. 1 is a block diagram of a prior art transcoder;

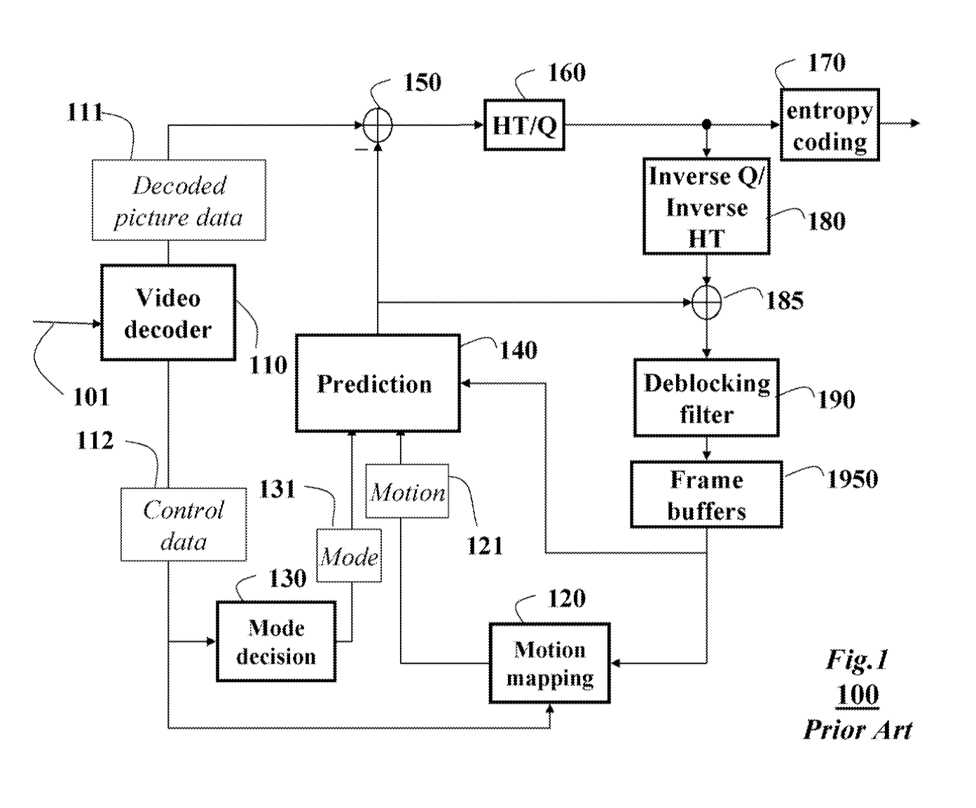

FIG. 2 is a block diagram of a method for mapping motion vectors between blocks with different sizes according to an embodiment of the invention;

FIG. 3 is a block diagram of motion vector mapping for a 16×8 macroblock partition from a set of input motion vectors according to an embodiment of the invention;

FIG. 4 is a block diagram of the motion vector mapping for an 8×16 macroblock partition from a set of input motion vectors according to an embodiment of the invention;

FIG. 5 is a block diagram of motion vector mapping for an 8×8 macroblock partition from a set of input motion vectors according to an embodiment of the invention;

FIG. 6 is a block diagram of the motion vector mapping for a 8×8 macroblock partition from a set of input motion vectors of different block sizes according to an embodiment of the invention; and

FIG. 7 is a block diagram of the motion vector mapping for a 16×8 macroblock partition from a set of input motion vectors of causal neighbors according to an embodiment of the invention.

### DETAILED DESCRIPTION OF THE PREFERRED EMBODIMENT

The H.264/AVC standard specifies seven block sizes for inter prediction, i.e. 16×16, 16×8, 8×16, 8×8, 8×4, 4×8, and 4×4, while the MPEG-2 standard specifies two sizes, 16×16 or 16×8. This requires mapping map motion vectors corresponding to given block sizes to a much wider range of block sizes, when transcoding videos from MPEG-2 to H.264/AVC.

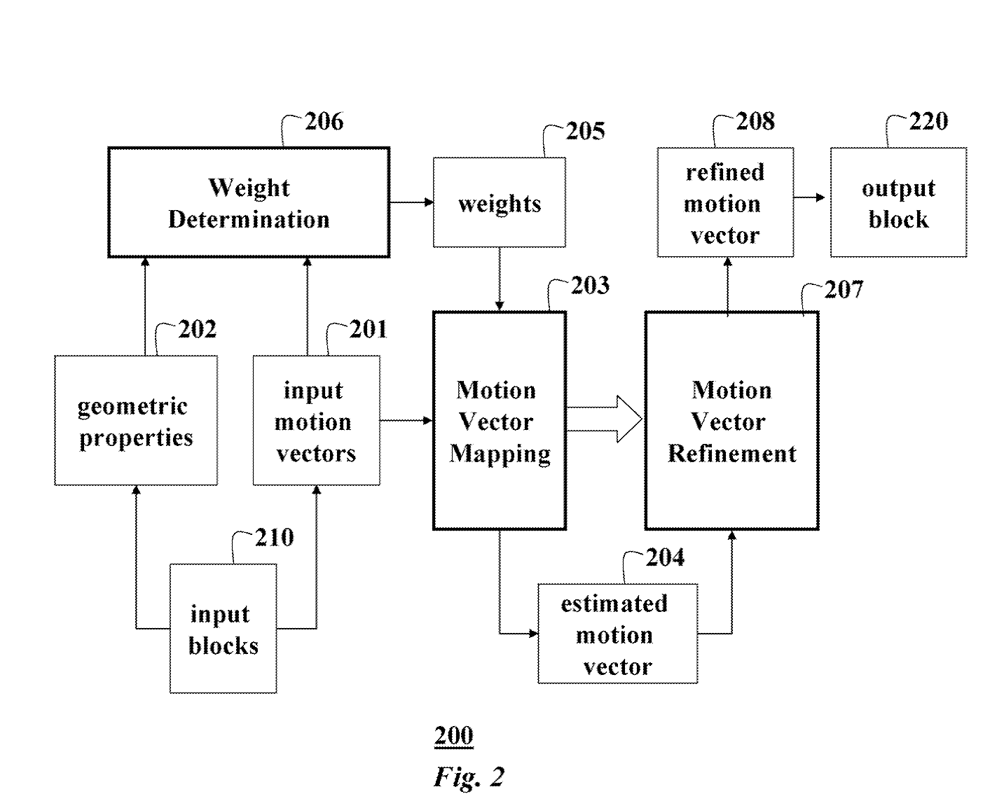

As shown in FIG. 2, our invention provides a method 200 for motion vector mapping 203, which determines a motion vector 208 of a output block 220 using a set of input motion vectors 201 based on a set of input blocks 210. The set of input blocks 210 either overlap or are neighboring to the output block 220. The output block can be a different size than the input block. As defined herein, a set can include one or more members. There is a trade-off between the extent of the neighborhood and the effectiveness of the mapping. Too few blocks may not provide enough input data, while too many blocks may introduce noise.

The set of input motion vectors 201 associated with the set of input blocks 210 is subject to motion vector mapping 203 to yield an estimated motion vector 204. The motion vector mapping 203 makes use of a set of weights 205. There is one weight for each input block 210. The mapping 203 is determined as either a weighted average or a weighted median. Other operations can also be applied. The weights 205 are based on the input motion vectors 201 and spatial properties 202 of the set of input blocks 201 using a weight determination 206. The estimated motion vector 204 is then subject to an optional motion vector refinement 207 to yield a refined motion vector 208 for the output block 220. Further details on the motion vector mapping method 203 and weight determination 206 are described below.

Without loss of generality, it is assumed that an input MPEG-2 video is encoded using frame pictures, which is the more popular MPEG-2 encoding method. Also, it is assumed that the output is encoded using H.264/AVC frame pictures without a use of a macroblock adaptive frame/field (MBAFF). These assumptions are made only to simplify the description of the invention, and are not required to work the invention. It is understood that the embodiments of the invention are generally applicable for field picture input, frame picture output with MBAFF, or field picture output, i.e., any block based vide encoding method.

The motion vector of a block is the same as the motion vector of its geometric center. Consequently, one input to the motion vector mapping 203 is the geometric centers of the set of input blocks 210, and the output is the motion vector 208 of the geometric center of the output block 220. The motion vector can be derived as a weighted average or weighted median of the set of input motion vectors 210.

It should be noted that the set of input blocks can be obtained from an input bitstream and the output block is for an output bitstream. Alternatively, the set of input blocks are obtained from blocks previously encoded in the input bitstream, and the output block is an output block of a decoded picture. In addition, the output motion vector can be a predicted motion vector that is used to reconstruct the output block of a decoded picture. A residual motion vector of the output block of the decoded picture can be decoded, and a sum of the predicted motion vector and the residual motion vector yields a reconstructed motion vector that is used to reconstruct the output block of the decoded picture.

Weight Determination

In the embodiments of the invention, the weights 205 are based on the spatial properties 202 of the input blocks 201 and the set of input motion vectors 201. Alternative embodiments are described below.

One embodiment of the invention, the weight 205 for each input motion vector 201 is inversely proportional to the distance between geometric centers of the corresponding input block and the output block.

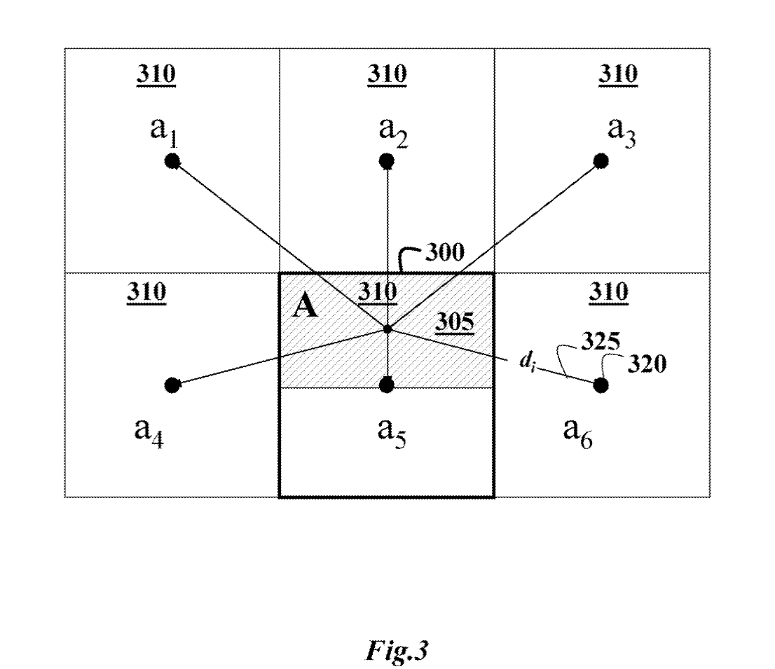

FIG. 3 shows a output macroblock of size 16×16 (heavy line) 300, a cross-hatched output macroblock block partition “A” 305 of size 16×8, and six input macroblocks 310, labeled as “a₁” through “a₆”, respectively. The input macroblocks “a₅” overlaps is the output macroblock 300. The geometric centers of each input macroblock 310 and the output macroblock partition “A” 300 are shown as dots 320.

If one motion vector is associated with each of the input macroblocks “a₁” through “a₆”, then a weight ωᵢ is proportional to the distance between the geometric center of the input macroblock “aᵢ” and that of the target macroblock partition “A”. Each distance dᵢ between each geometric center of each input block and the partition 305 is shown as a line 325.

In this case, distances dᵢ are {5/2, 3/2, 5/2, \sqrt{17}/2, 1/2, \sqrt{17}/2}, assuming an eight pixel distance is equal to 1. We normalize these distances one to get respective weights:

$${ω}_{i} = \frac{\frac{1}{{d}_{i}}}{{\sum }_{i = 1}^{6} \frac{1}{{d}_{i}}} . \qquad ( 1 )$$

That is, the weights are inversely proportional to the distance. For this particular case, the set of weights for the set of input motion vectors are:

ωᵢ={0.0902, 0.1503, 0.0902, 0.1093, 0.4508, 0.1093}, (2)

which sum to 1.

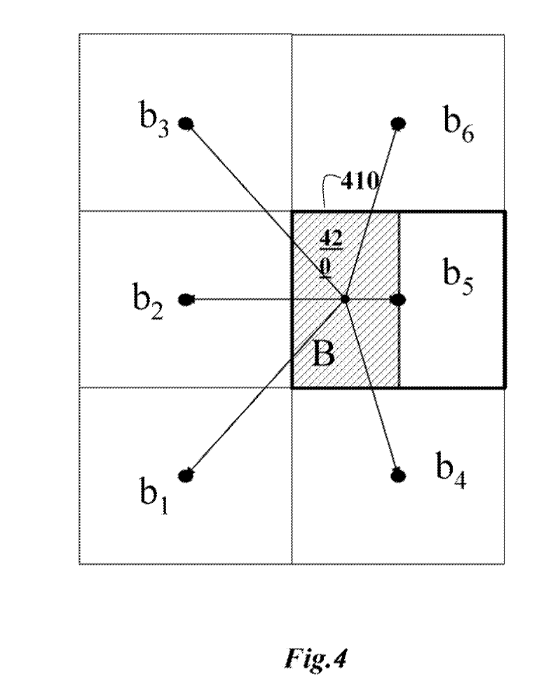

FIG. 4 shows a output macroblock (heavy line) 410, a output macroblock partition “B” 420 of size 8×16, and a set of six input macroblocks, labeled as “b₁” through “b₆”, respectively. The geometric centers and centers are also shown.

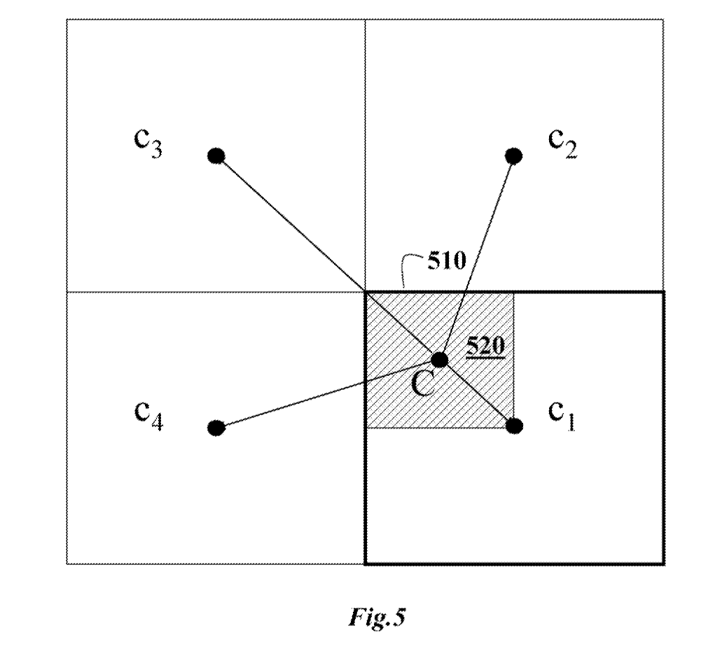

FIG. 5 shows a output macroblock 510, an output macroblock partition “C” 520 of size 8×8, and a set of four input macroblocks, labeled as “c₁” through “c₄”, respectively.

Similar to the descriptions for FIG. 3, the motion vectors of the output macroblock partitions “B” and “C”, as shown in FIG. 4 and FIG. 5, can be estimated using weighted average of the set of input motion vectors.

In another embodiment, the weights ω also depend on the sizes of the input blocks. This is particularly useful when the input blocks are different sizes than the output block. In this case, the weight is proportional to the size.

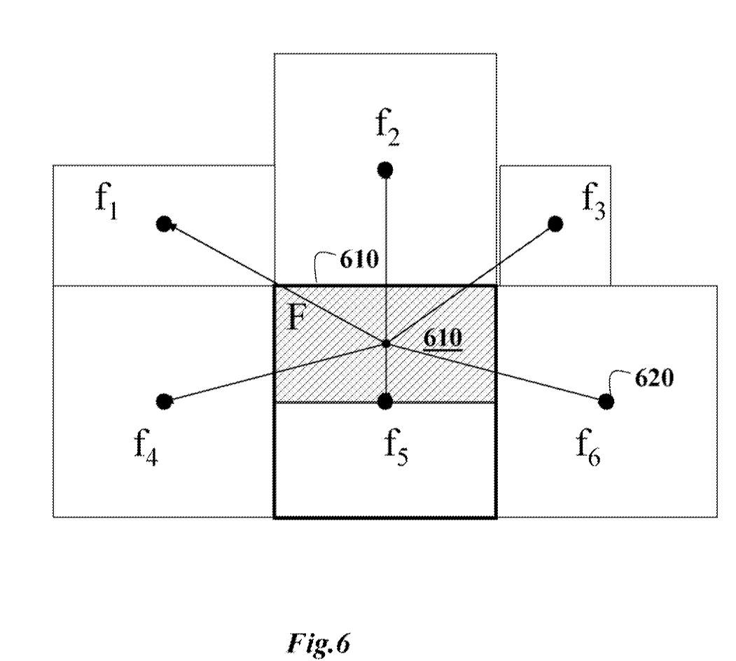

FIG. 6 shows a output macroblock (heavy line) 610 of size 16×16, a output macroblock block partition “F” 620 of size 16×8, and a set of six input macroblocks, labeled as “f₁” through “f₆”, respectively. The geometric centers and distances are also shown. In this case, each weight is determined as:

$${ω}_{i} = \frac{\frac{1}{{d}_{i}} \times {b}_{i}}{{\sum }_{i = 1}^{6} ( \frac{1}{{d}_{i}} \times {b}_{i} )} , \qquad ( 3 )$$

where dᵢ is the distance between geometric center of each input block “fᵢ” and the output macroblock partition “F” 620, bᵢ is the smaller dimension of the input block, which is determined by the block size. For example bᵢ is 8 for “f₁” and 4 for “f₃”. Alternatively, b can be the area (size) of the input block. The weights can be determined in a similar manner for other input and output block sizes. Thus, the weight can be distance, a dimension, an area, or combinations thereof. The weight is set to zero for a input motion vector if the input motion vector is not available, or the input motion vector is determined to be an outlier not to be used.

One process for determining whether a motion vector V is an outlier is described in the following. Let V_{avg} be an average of all input motion vectors. Then, V is considered an outlier if |V-V_{avg}| is greater than a predetermined threshold T, where |V-V_{avg}|=|Vₓ-V_{avg.x}|+|V_{y}-V_{avg.y}|, Vₓ, V_{y} are x and y components of the vector V, and V_{avg.x}, V_{avg.y} are the x and y components of the vector V_{avg}.

Motion Vector Mapping and Refinement

With the set of weights {ω₁}, for i=1, 2, . . . , N, and the set of input motion vectors {V₁}, we estimate the output motion vector Vₒ for the output block using a weighted average

$${V}_{o} = \frac{{\sum }_{i = 1}^{N} ( {ω}_{i} \times {V}_{i} )}{{\sum }_{i = 1}^{N} {ω}_{i}} . \qquad ( 4 )$$

or a weighted median

$$\{ \begin{matrix}{V}_{o} ∈ \{ {V}_{i} \} \\ {\sum }_{i = 1}^{N} {ω}_{i} ‖ {V}_{i} - {V}_{i} ‖ \leq {\sum }_{i = 1}^{N} {ω}_{i} ‖ {V}_{j} - {V}_{i} ‖ j = 1 , 2 , … , N .\end{matrix} \qquad ( 5 )$$

After the weighted average or median operation, the resulting motion vector can be subject to the refinement process 207, e.g., when the estimate motion vector is used to perform motion compensated prediction. Motion vector refinement is a well known method for making relatively small adjustments to a motion vector so that a prediction error is minimized within a small local area of interest, see A. Vetro, C. Christopoulos, and H. Sun, “Video transcoding architectures and techniques: an overview,” IEEE Signal Processing Mag. 20(2): 18-29, March 2003, incorporated herein by reference.

During transcoding from MPEG-2 and H.263, to H.264/AVC, the invention can be used to efficiently estimate motion vectors of different block sizes for H.264/AVC encoding from motion vectors decoded form the input video bitstream.

The invention can also be used to efficiently encode motion vectors during video encoding. The output motion vector can use the motion vector estimated from motion vectors of neighboring blocks as a predictor, and then only the difference between the output motion vector and the predictor is signaled to the decoder. Decoding is the reverse process.

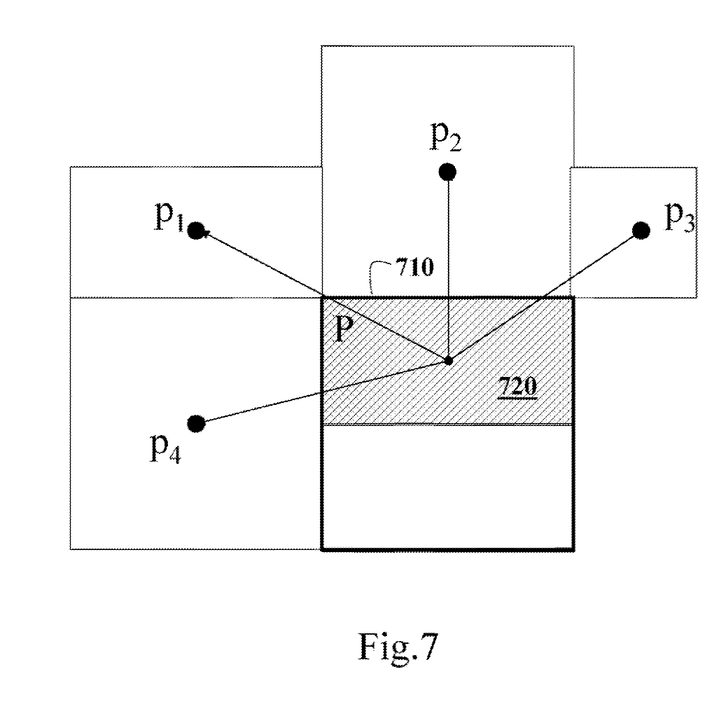

This idea is shown in FIG. 7, where a output macroblock partition “P” 710 and four causal neighboring blocks “p₁” through “p₄” are shown. In this case, the motion vector for the partition (shaded) “P” 620 can be encoded using the motion vector estimated from the motion vector of the set of blocks “p₁” through “p_{4”} as a predictor.

This approach is more general than a translational macroblock motion model used in conventional encoding. Even when there are motions like zoom-in or zoom-out, the motion vector of a rectangular macroblock can be considered to be approximately the same as the motion vector of its geometric center.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A computer implemented method for mapping motion vectors, comprising the steps of:
determining a set of weights for a set of motion vectors of a set of input blocks, there being one weight for each motion vector of each input block; and
mapping the set of motion vectors to an output motion vector of an output block according to the set of weights.

2. The method of claim 1, in which the weight depends on a distance of a geometric center of the input block to a geometric center of the output block.

3. The method of claim 1, in which the weight depends on a size of the input block.

4. The method of claim 1, in which the weight depends on a distant of a geometric center of the input block to a geometric center of the output block, and on a size of the input block.

5. The method of claim 1, in which the set of input blocks is encoded according to a MPEG-2 standard, and the output block is encoded according to a H.264/AVC standard.

6. The method of claim 1, in which the set of input blocks has sizes different than the output block.

7. The method of claim 1, in which the set of input blocks overlaps the output block.

8. The method of claim 1, in which the set of input blocks is neighboring to the output block.

9. The method of claim 1, in which the set of input blocks overlaps and are neighboring to the output block.

10. The method of claim 1, in which them mapping uses a weighted median.

11. The method of claim 1, further comprising:
refining the output motion vector.

12. The method of claim 2, in which the weight is inversely proportional to the distance.

13. The method of claim 3, in which the weight is proportional to the size.

14. The method of claim 2, in which the weight is
$${ω}_{i} = \frac{\frac{1}{{d}_{i}}}{{\sum }_{i = 1}^{6} \frac{1}{{d}_{i}}} ,$$
where dᵢ is the distance.

15. The method of claim 3 in which the weight is
$${ω}_{i} = \frac{\frac{1}{{d}_{i}} \times {b}_{i}}{{\sum }_{i = 1}^{6} ( \frac{1}{{d}_{i}} \times {b}_{i} )} ,$$
where dᵢ is the distance and b is a smaller dimension of the input block.

16. The method of claim 1, in which the weight is zero if the motion vector is an outlier.

17. The method of claim 14, in which the output motion vector is
$${V}_{o} = \frac{{\sum }_{i = 1}^{N} ( {ω}_{i} \times {V}_{i} )}{{\sum }_{i = 1}^{N} {ω}_{i}} ,$$
where Vᵢ is the set of input motion vectors.

18. The method of claim 14, in which the output motion vector is
$$\{ \begin{matrix}{V}_{o} ∈ \{ {V}_{i} \} \\ {\sum }_{i = 1}^{N} {ω}_{i} ‖ {V}_{i} - {V}_{i} ‖ \leq {\sum }_{i = 1}^{N} {ω}_{i} ‖ {V}_{j} - {V}_{i} ‖ j = 1 , 2 , … , N .\end{matrix} \qquad ( 5 )$$
where Vᵢ is the set of input motion vectors.

19. The method of claim 1, in which the set of input blocks are obtained from the input bitstream and the output block is for the output bitstream.

20. The method of claim 1, in which the set of input blocks are obtained from blocks previously encoded in the input bitstream, and output block is an output block of a decoded picture.

21. The method of claim 1, in which the output motion vector is a predicted motion vector that is used to reconstruct the output block of a decoded picture.

22. The method of claim 21, in which a residual motion vector of the output block of the decoded picture is decoded.

23. The method of claims 21, in which a sum of the predicted motion vector and the residual motion vector yields a reconstructed motion vector that is used to reconstruct the output block of the decoded picture.

24. A transcoder for mapping motion vectors, comprising:
means for determining a set of weights for a set of motion vectors of a set of input blocks of an input bitstream, there being one weight for each motion vector of each input block; and
means for mapping the set of motion vectors to an output motion vector of an output block of an output bitstream according to the set of weights.

25. The transcoder of claim 24, further comprising:
means for refining the output motion vector.

26. A decoder for mapping motion vectors, comprising:
means for determining a set of weights for a set of motion vectors of a set of input blocks of an input bitstream, there being one weight for each motion vector of each input block; and
means for mapping the set of motion vectors to an output motion vector of an output block of a decoded picture according to the set of weights.
